(19) United States
(12) Patent Application Publication
(10) Pub. No.: US 2007/0179922 A1
(43) Pub. Date: Aug. 2, 2007

(54) Apparatus and method for forecasting control chart data

(75) Inventor: John Malcolm MacGregor, Ascot (GB)

Correspondence Address: COOLEY GODWARD KRONISH LLP;ATTN: Patent Group, Suite 500, 1200 - 19th Street, NW, Washington, DC, 20036-2402, US

(73) Assignee: Business Objects, S.A., Levallois-Perret (FR)

(21) Appl. No.: 11/344,587

(22) Filed: Jan. 30, 2006

(51) Int. Cl. G06F 15/18

(52) U.S. Cl. 706/21

(57) ABSTRACT

A computer-readable medium to direct a computer to function in a specified manner includes executable instructions to construct a control chart containing business data values and defined control limits. A forecast is then made for the control chart and the results of the forecast are then specified.

### CROSS-REFERENCE TO RELATED APPLICATION

This application is related to the commonly owned application entitled “Apparatus and Method for Forecasting Data Using Fuzzy Boundaries”, filed Jan. 30, 2006, U.S. Ser. No. ______.

### BRIEF DESCRIPTION OF THE INVENTION

The present invention relates generally to tracking data. More particularly, the present invention relates to a technique for analyzing and forecasting process control data.

### BACKGROUND OF THE INVENTION

Business Intelligence (BI) generally refers to software tools used to improve business enterprise decision-making. These tools are commonly applied to financial, human resource, marketing, sales, customer and supplier analyses. More specifically, these tools can include: reporting and analysis tools to present information; content delivery infrastructure systems for delivery and management of reports and analytics; data warehousing systems for cleansing and consolidating information from disparate sources; and data management systems, such as relational databases or On Line Analytic Processing (OLAP) systems used to collect, store, and manage raw data.

There are a number of commercially available products to produce reports from stored data. For instance, Business Objects Americas of San Jose, California, sells a number of widely used report generation products, including Crystal Reports™, Business Objects OLAP Intelligence™, and Business Objects Enterprise™. As used herein, the term report refers to information automatically retrieved (i.e., in response to computer executable instructions) from a data source (e.g., a database, a data warehouse, and the like), where the information is structured in accordance with a report schema that specifies the form in which the information should be presented. A non-report is an electronic document that is constructed without the automatic retrieval (i.e., in response to computer executable instructions) of information from a data source. Examples of non-report electronic documents include typical business application documents, such as a word processor document, a presentation document, and the like.

A report document is generally created by a specialized tool including executable instructions to access data and format it. A report document where the content does not include external data, either saved within the report or accessed live, is a template document for a report rather than a report document. Unlike, other non-report documents that may optionally import external data within a document, a report document by design is primarily a medium for accessing, formatting, and presenting external data.

A report design tool contains executable instructions specifically designed to facilitate working with external data sources. In addition to instructions regarding external data source connection drivers, these instructions may include advanced filtering of data, instructions for combining data from different external data sources, instructions for updating join structures and relationships in report data, and instructions including logic to support a more complex internal data model (that may include additional constraints, relationships, and metadata).

In contrast to a spreadsheet type application, a report generation tool is generally not limited to a table structure but can support a range of structures. A report design tool is designed primarily to support imported external data, whereas a spreadsheet application equally facilitates manually entered data and imported data. In both cases, a spreadsheet application applies a spatial logic that is based on the table cell layout within the spreadsheet in order to interpret data and perform calculations on the data. In contrast, a report design tool is not limited to logic that is based on the display of the data, but rather can interpret the data and perform calculations based on the original (or a redefined) data structure and meaning of the imported data. Spreadsheets applications work within a looping calculation model, whereas report generation tools may support a range of calculation models. Although there may be an overlap in the function of a spreadsheet document and a report document, the applications used to generate these documents contain instructions with different assumptions concerning the existence of an external data source and different logical approaches to interpreting and manipulating imported data.

The present invention relates to the analytical and reporting aspects of BI. Analyzing and predicting the effect that business records have on an enterprise has become increasingly more valuable and complex. A business record or business data value is a measure of the operation of an enterprise (e.g., commercial, governmental, non-profit, etc.). The business data value may be financial, human resource, marketing, sales, customer or supplier information. One method for analyzing business records is a control chart. A control chart comprises business data values and associated control limits. While there are existing tools to create control charts, these tools do not specifically predict the effects that the data in a control chart may have on future business records within an enterprise.

Therefore, it would be desirable to provide for a new technique to use business records as a predictive driver in analyzing the performance of a business. In particular, it would be desirable to provide a method to forecast future business records to allow for action before a specified event occurs.

### SUMMARY OF THE INVENTION

The invention includes a computer-readable medium to direct a computer to function in a specified manner. The computer-readable medium stores executable instructions to construct a control chart containing business data values and defined control limits. A forecast is then made for the control chart and the results of the forecast are then specified.

### BRIEF DESCRIPTION OF THE DRAWINGS

For a better understanding of the nature and objects of the invention, reference should be made to the following detailed description taken in conjunction with the accompanying drawings, in which:

FIG. 1 illustrates a computer that may be operated in accordance with an embodiment of the invention.

FIG. 2 illustrates processing operations performed in accordance with an embodiment of the invention.

FIG. 3 illustrates an exemplary control chart that may be processed in accordance with an embodiment of the invention.

FIG. 4 illustrates the results of the forecasting made on the control chart of FIG. 3.

### DETAILED DESCRIPTION OF THE INVENTION

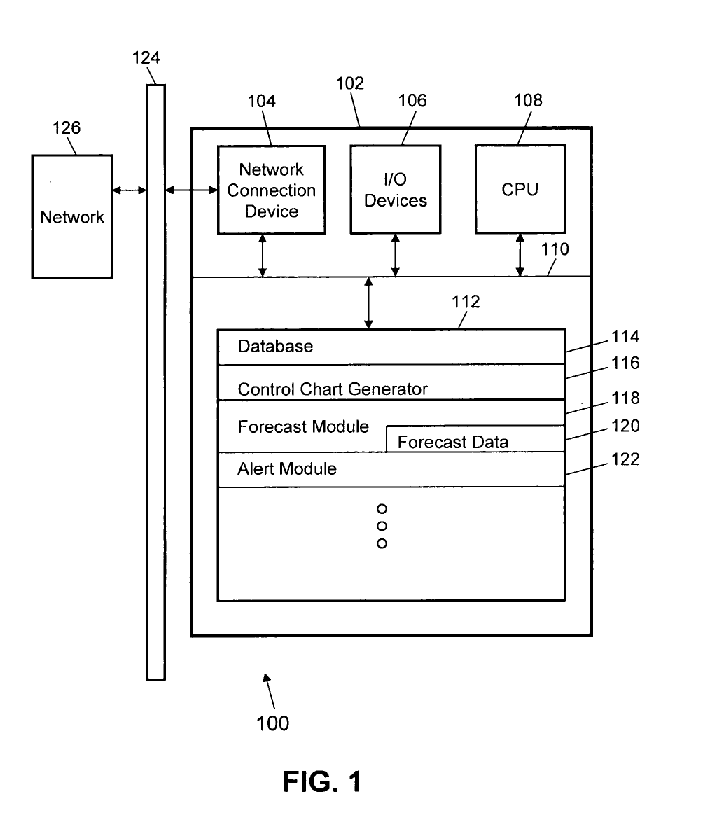

FIG. 1 illustrates a computer network 100 that may be operated in accordance with an embodiment of the invention. The computer network 100 includes a computer 102, which, in general, may be a client computer or a server computer. In the present embodiment of the invention, the computer 102 is a server computer including conventional server computer components. As shown in FIG. 1, the computer 102 includes a Central Processing Unit (“CPU”) 108 that is connected to a network connection device 104 and a set of input/output devices 106 (e.g., a keyboard, a mouse, a display, a printer, a speaker, and so forth) via a bus 110. The network connection device 104 is connected to network 126 through the network transport medium 124, which may be any wired or wireless transport medium.

The CPU 108 is also connected to a memory 112 via the bus 110. The memory 112 stores a set of executable programs. One executable program is the control chart generator 116. The control chart generator 116 includes executable instructions to access a data source to produce a control chart. By way of example, the data source may be database 114 resident in memory 112. The data source may be located anywhere in the network 126. A control chart is an instrument that may be used by an enterprise to present business records in relationship to user or system defined control limits and other business records.

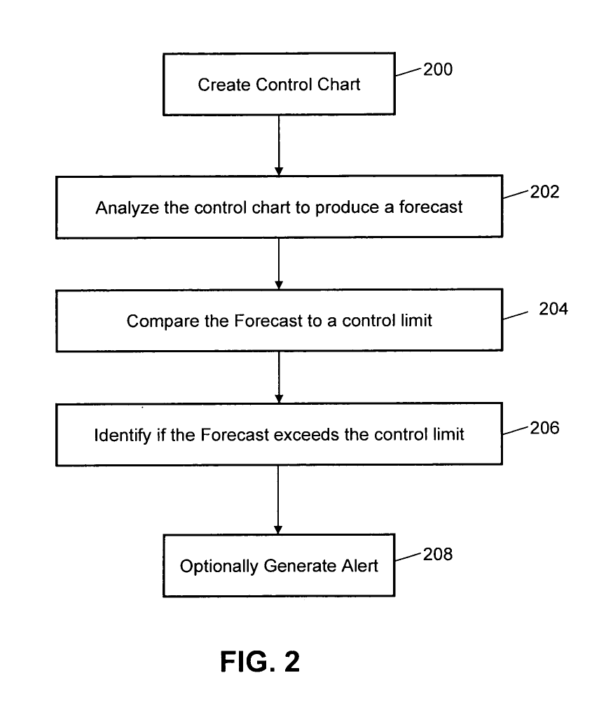

As shown in FIG. 1, the memory 112 also contains a forecast module 118. The forecast module 118 processes the control chart generated by the control chart generator 116. The forecast module 118 is used to determine whether a forecast can be made in a control chart and outputs the results as forecast data 120. By producing a forecast for a control chart, the forecast module 118 allows businesses the ability to determine whether a threshold limit will be exceeded by a future event before that event happens. The forecast module 118 can operate in conjunction with the alert module 122 to alert the user of the results of the forecast. In one embodiment of the invention, the forecast module 118 processes a control chart generated by the control chart generator 116 according to the operations illustrated in FIG. 2.

While the various components of memory 112 are shown residing in the single computer 100, it should be recognized that such a configuration is not required in all applications. For instance, the forecast module 118 may reside in a separate computer (not shown in FIG. 1) that is connected to the network 126. Similarly, separate modules of executable code are not required. The invention is directed toward the operations disclosed herein. There are any number of ways and locations to implement those operations, all of which should be considered within the scope of the invention.

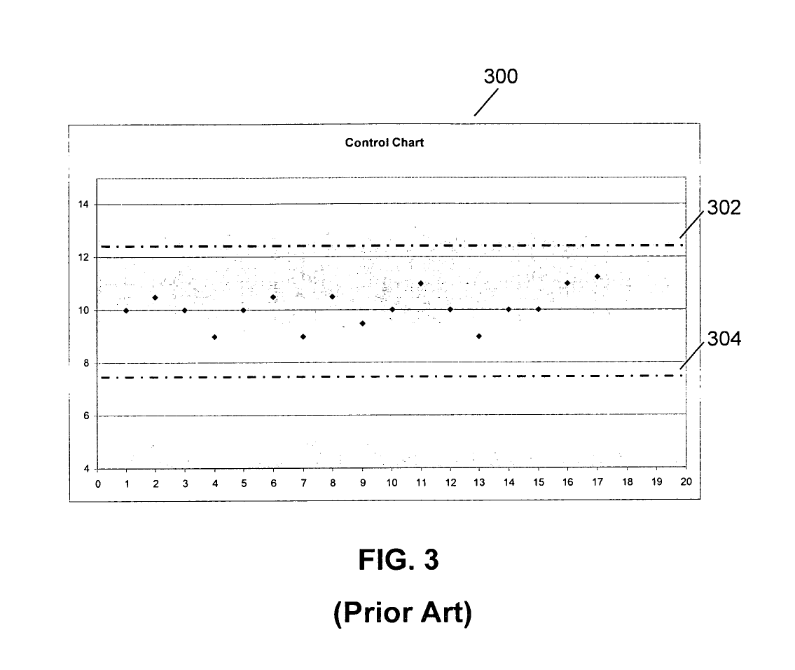

The first processing operation shown in FIG. 2 is to create a control chart 200. In one embodiment, this is implemented with executable code of the control chart generator 116. An example of a control chart that may exist in the prior art is shown in FIG. 3. FIG. 3 illustrates a control chart 300 containing various business data values recorded for a period 1 to 17, defined by the horizontal axis. An upper limit 302 is defined by the vertical axis, as is a lower tolerance limit 304. The business data values may represent various business records or other past events in a business. For example, the business data values may represent the average time taken to answer a call in a call center over a specified period of time. The control chart 300 may specify different days over a given period and the average time to answer a call on each of the days. Additionally, the control chart 300 includes control or tolerance limits 302, 304 that define the level at which a business wishes to be alerted when a tolerance limit is crossed. For instance, a business may wish to be alerted if its call center response time exceeds a certain threshold limit. Accordingly, the control chart 300 enables a business to determine if and when a tolerance limit was exceeded by previous events by presenting former business records for a specified period in relationship to control limits and other business data values.

Returning to FIG. 2, the next processing operation is to analyze the control chart to produce a forecast 202. The forecast module 118 will determine if any pattern can be identified in the control chart and generates the result of any forecast, which constitutes forecast data 120. The user may define the number of business data values that the forecast module 118 is to analyze. The forecast module 118 may define a plurality of patterns that may be referred to as candidate patterns to search for in the control chart. Exemplary patterns that can be identified by the forecast module 118 include linear positive patterns, linear negative patterns, non-linear positive patterns, non-linear negative patterns, cyclical patterns, and random behavior patterns. These patterns can be identified using the techniques described in the commonly owned patent application entitled “Apparatus and Method for Identifying Patterns in a Multi-Dimensional Database”, Ser. No. 10/113,917, filed Mar. 28, 2002.

Various statistical tests may be applied to the control chart to identify these patterns. For example, the invention may be implemented using Runs Test, a Mean Successive Squared Difference Test, an Autocorrelation Test, a Tukey Test, a Variance Test, and a Regression Analysis.

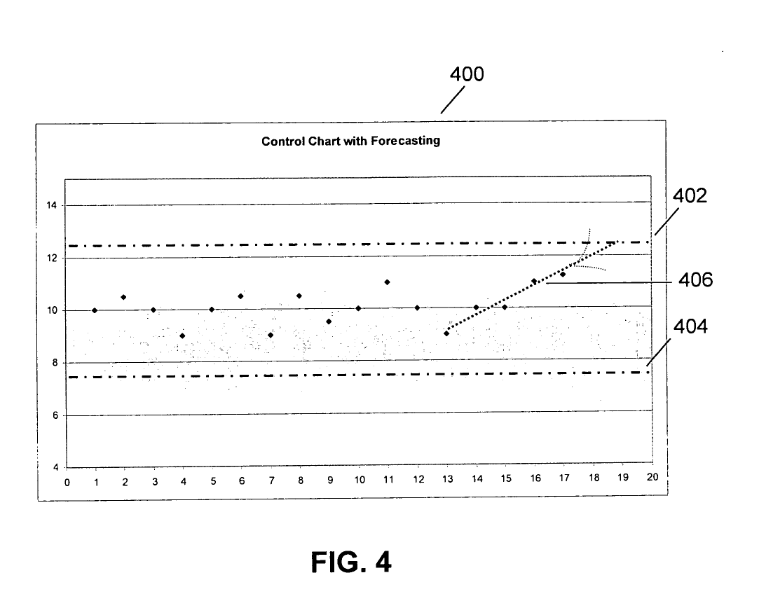

As shown in FIG. 2, the next processing operation is to compare the forecast to a control limit 204. If no forecast is made, then no comparison is performed and the user may run an altered analysis of the control chart by changing the number of business data values to analyze. However, if a forecast is made and a pattern is identified, then the result of the forecast is compared to the control limits of the control chart. This may be accomplished through visual inspection by the user or by the forecast module 118. For example, FIG. 4 presents the results of a forecast, a control chart with forecasting 400, made by the forecast module 118 on business data values 13-17. In this example, the forecast module 118 identified a positive linear pattern in the data points and forecasted the effect this would have on future values. A comparison is then made by visual inspection or by the forecast module 118 between the magnitude of the upper control limit 402 and the result of the forecast.

Returning to FIG. 2, the next processing operation is to identify if the forecast exceeds the control limit 206. Depending on the outcome of the comparison between the forecast and control limit, the user or the forecast module 118 may identify that the forecast exceeds the control limit. For instance, the user or forecast module 118 may identify that the forecast made in the control chart with forecasting 400 exceeds the upper control limit 402.

As shown in FIG. 2, the last processing operation is for the alert module 122 to optionally generate an alert 208 if the forecast exceeds the control limit. By way of example, the alert may be delivered via an email message. Alternately, the alert may be a visual indicator, such as a dashed line, a bold font or change in font color associated with the forecast information. For example, the control chart with forecasting 400 may include a dashed forecast line 406 that alerts a business that the upper control limit 402 may be exceeded within the next few periods. This allows a business the ability to predict whether a control limit will be exceeded by a future event before that event happens.

Ultimately, this enables a business to take action in response to a control limit being exceeded before it is actually exceeded rather than reacting after an event has taken place. For example, control chart 300 may represent the average time taken to answer a call in a call center for a firm and the firm may determine that they do not want the average time to exceed the upper control limit defined. In this example, the control chart with forecasting 400 indicates that a positive linear pattern exists in the period of 13-17 and the upper control limit 402 may soon be exceeded. The firm now has the opportunity to take corrective action to pre-empt the upper limit from being exceeded before it actually is. This gives a business the ability to act rather than react to future events.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

While the present invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, process step or steps, to the objective, spirit and scope of the present invention. All such modifications are intended to be within the scope of the claims appended hereto. In particular, while the methods disclosed herein have been described with reference to particular steps performed in a particular order, it will be understood that these steps may be combined, sub-divided, or re-ordered to form an equivalent method without departing from the teachings of the present invention. Accordingly, unless specifically indicated herein, the order and grouping of the steps is not a limitation of the present invention.

1. A computer-readable storage medium to direct a computer to function in a specified manner, comprising executable instructions to:
construct a control chart characterizing business data values and control limits, wherein the business data values are selected from financial, human resource, marketing, sales, customer and supplier data;
identify a pattern in the control chart;
apply regression analysis to the control chart to produce a forecast;
compare the forecast to a control limit;
determine if the forecast exceeds the control limit; and
report an alert.

2. (canceled)

3. (canceled)

4. The computer-readable storage medium of claim 1, wherein the executable instructions to apply regression analysis include executable instructions to identify linear and non-linear curves.

5. The computer-readable storage medium of claim 1, wherein the executable instructions to construct a control chart include executable instructions to define said control limits.

6. The computer-readable storage medium of claim 1, wherein the executable instructions to determine include executable instructions to visually depict a forecast.

7. (canceled)

8. The computer-readable storage medium of claim 1, wherein the executable instructions to report an alert include executable instructions to provide regression analysis information.

9. The computer-readable storage medium of claim 1, wherein the executable instructions to report an alert include executable instructions to generate an alert email.

10. The computer-readable storage medium of claim 1, wherein the executable instructions to report an alert include executable instructions to present an alert visual indicator.
